(19) United States
(12) Patent Application Publication
(10) Pub. No.: US 2014/0225447 A1
(43) Pub. Date: Aug. 14, 2014

(54) HIGH-FREQUENCY WIRELESS POWER SYSTEM

(71) Applicant: Triune IP LLC, Richardson, TX (US)

(72) Inventor: Ross E. Teggatz, McKinney, TX (US)

(73) Assignee: Triune IP LLC, Richardson, TX (US)

(21) Appl. No.: 14/178,161

(22) Filed: Feb. 11, 2014

Related U.S. Application Data
(60) Provisional application No. 61/763,180, filed on Feb. 11, 2013.

(51) Int. Cl. H02J 7/02; H01F 38/14; H02J 17/00

(52) U.S. Cl. CPC H02J 7/025; H02J 17/00; H01F 38/14
USPC 307/104

(57) ABSTRACT

A high-frequency wireless power system with at least one antenna port and at least one asymmetric conductance device operatively coupled to the at least one antenna port. The at least one asymmetric conductance device includes a first terminal and a second terminal, with at least one cross-over break switch operatively coupled across the first terminal and the second terminal. The system further includes at least one control circuit operatively coupled to the at least one cross-over break switch to control the at least one cross-over break switch.

### PRIORITY ENTITLEMENT

This non-provisional patent application claims priority to U.S. Provisional Patent Application Ser. No. 61/763,180 filed on Feb. 11, 2013, entitled “HIGH-FREQUENCY WIRELESS POWER SYSTEM,” which is herein incorporated by reference in its entirety. This application and the Provisional Patent Application have at least one common inventor.

### TECHNICAL FIELD

Embodiments of the present invention relate to storage device charging systems. More particularly, embodiments of the present invention relate to a system and method for high-frequency wireless power charging.

### BACKGROUND

Wireless charging is based on the principle of magnetic induction, which is the manipulation of electromagnetic fields produced by electrons moving within a wire loop. These electromagnetic fields radiate perpendicularly to the axis of the loop. These loops may either be small, in which the receiver loop is closely aligned with the transmitter loop, or large in which case the transmitter and receiver do not need to be closely aligned. This difference in transmitter loop size and frequency affects both the power requirements and the efficiency of the energy transfer.

Currently there are at least three standards bodies that are proposing differing standards and transmitter/receiver frequencies. The first wireless power standard is the Wireless Power Consortium (WPC), which established the Qi standard, the Power Maters Alliance (PMA), and the Alliance for Wireless Power (A4WP).

The lower frequency Qi standard uses a wireless transmission frequency of 100 khz to 200 khz, PMA standards are in the range of 200 khz to 300 khz and higher frequency A4WP standard uses 6.78 Mhz. There are other standards that also operate at a much higher frequency, such as 12 Mhz and beyond. As such, a wireless receiver capable of simultaneously supporting multiple standards is needed.

To transfer high frequency AC power to a DC load, diode configurations are generally utilized. A prior art implementation of such a system 100 is shown in FIG. 1, in the form of a bridge rectifier. Diodes and Schottky diodes may be used in this implementation. A limitation of this bridge rectifier implementation is that the forward voltage drop times the current to the load creates significant power loss in the system.

To accommodate varied frequency ranges, different implementations for a front end (i.e., a wireless receiver) that minimizes losses and maximizes efficiency of the system is required.

### SUMMARY

Accordingly, embodiments of the present invention include a high-frequency wireless power system, comprising at least one antenna port, at least one asymmetric conductance device operatively coupled to the at least one antenna port, the at least one asymmetric conductance device having a first terminal and a second terminal, at least one cross-over break switch operatively coupled across the first terminal and the second terminal and at least one control circuit operatively coupled to the at least one cross-over break switch to control the at least one cross-over break switch.

Another embodiment of the present invention includes a high-frequency wireless power system, comprising at least one antenna port to receive at least one electromagnetic signal, at least one rectifier operatively coupled to the at least one antenna port, the at least one rectifier having a bridge configuration having at least one bridge leg, at least one cross-over break switch operatively coupled across the at least one bridge leg and at least one control circuit operatively coupled to the at least one cross-over break switch to control the at least one cross-over break switch.

A further embodiment of the present invention includes a high-frequency wireless power system, comprising at least one antenna port to receive at least one electromagnetic signal, at least one bridge rectifier operatively coupled to the at least one antenna port, at least one load connected to an output of the at least one rectifier, at least one load switch operatively coupled to the at least one load and at least one control circuit operatively coupled to the at least one load switch to control the at least one load switch.

### BRIEF DESCRIPTION OF THE DRAWINGS

The present disclosure will be more clearly understood from consideration of the following detailed description and drawings in which:

FIG. 1 illustrates a prior-art example of a rectifier;

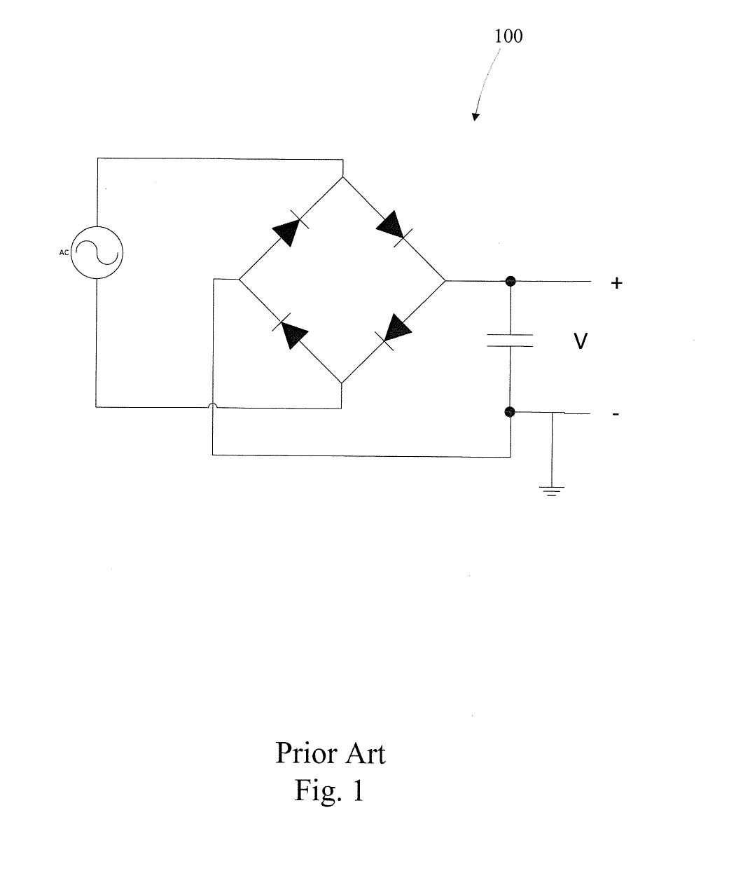

FIG. 2 shows a first example of a high-frequency wireless power system in accordance with one embodiment of the present invention;

FIG. 3 shows an example of a prediction of cross-over regions of an incoming alternating signal;

FIG. 4 shows an example of passive and active load control in accordance with embodiments of the present invention;

FIG. 5 shows an example of active switching for load control in accordance with embodiments of the present invention;

FIG. 6 shows a second example of a high-frequency wireless power system in accordance with one embodiment of the present invention;

FIG. 7 shows an example of gate drive stepping in accordance with one embodiment of the present invention; and

FIG. 8 shows an example of a transmitter and receiver having an adjustable load in accordance with one embodiment of the present invention.

References in the detailed description correspond to like references in the various drawings unless otherwise noted. Descriptive and directional terms used in the written description such as right, left, back, top, bottom, upper, side, et cetera, refer to the drawings themselves as laid out on the paper and not to physical limitations of the disclosure unless specifically noted. The drawings are not to scale, and some features of examples shown and discussed are simplified or amplified for illustrating principles and features as well as advantages of the disclosure.

### DETAILED DESCRIPTION

The features and other details of embodiments of the present invention will now be more particularly described with reference to the accompanying drawings, in which various illustrative examples of the disclosed subject matter are shown and/or described. It will be understood that particular examples described herein are shown by way of illustration and not as limitations of the disclosure. The disclosed subject matter should not be construed as limited to any of examples set forth herein. The principle features of this disclosure can be employed in various examples while remaining within the scope of embodiments of the present invention.

The terminology used herein is for the purpose of describing particular examples and is not intended to be limiting of the disclosed subject matter. Like numbers refer to like elements throughout. As used herein the term “and/or” includes any combination of one or more of the associated listed items. Also, as used herein, the singular forms “a”, “an”, and “the” are intended to include the plural forms as well, unless the context clearly indicates otherwise. It will be further understood that the terms “comprises”, and/or “comprising” when used in this specification, specify the presence of stated features, integers, steps, operations, elements, and/or components, but do not preclude the presence or addition of one or more other features, integers, steps, operations, elements, components, and/or groups thereof. Also, as used herein, relational terms such as first and second, top and bottom, left and right, and the like may be used solely to distinguish one entity or action from another entity or action without necessarily requiring or implying any actual such relationship or order between such entities or actions.

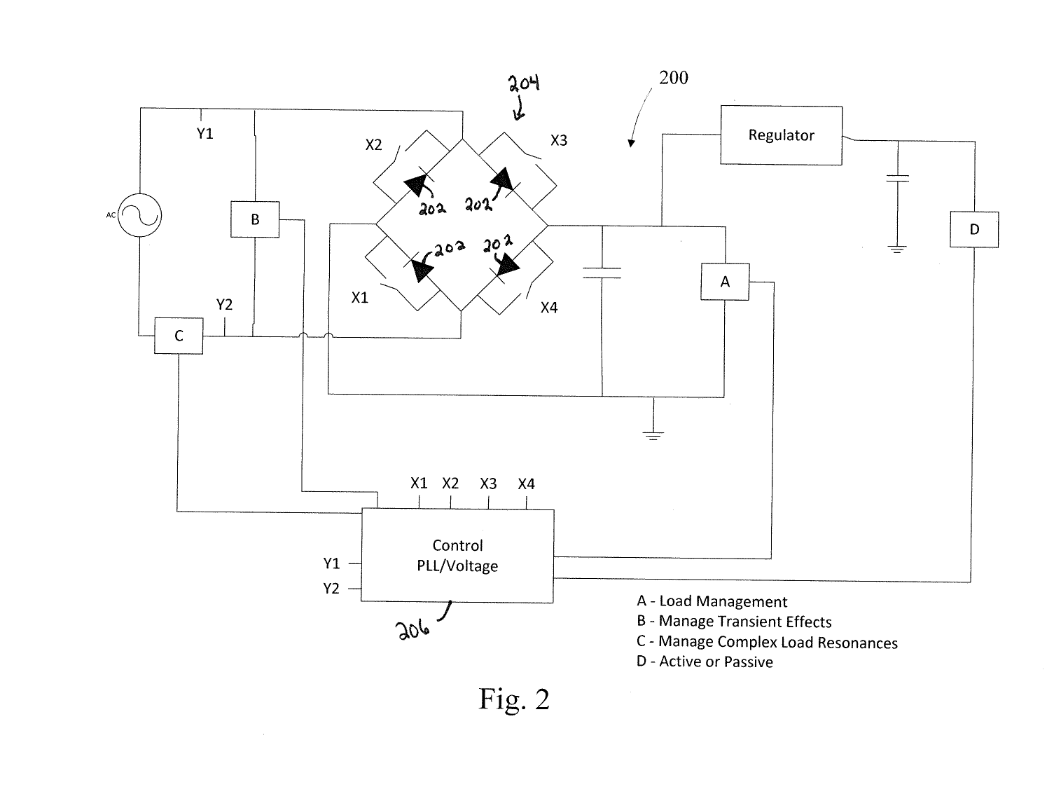

Embodiments of the present invention include a power system for controlling loads and for general system optimization. To control an AC load and to optimize the system, signal loads may be evaluated and adjusted at various locations throughout the system. FIG. 2 is illustrative of a front end of such a system 200, which is alternatively defined as a secondary side (i.e., a receiver), or a side that is receiving power from a primary side (i.e., a transmitter). As shown in FIG. 2, the front end includes an evaluation point A, in which the voltage and current may be evaluated and a DC load modulated. This load may be static or dynamic. If there is a quick load transient on the system, evaluation point A may dynamically adjust so that the load seen at the AC signal has a slower transient signal. Evaluation point A may then slowly, and transiently, adjust so that the overall system from the primary side of the system (not shown in FIG. 2) to the secondary side (which includes the AC signal) will slowly, and transiently, adjust. Systems for accomplishing this may include various components, such as a resonant converter with a feedback loop. However, the feedback mechanism to adjust the gain may be slow, or the secondary load can introduce noise to the feedback loop, causing instability. By providing a dynamic load at evaluation point A, and by making the loop from the primary to secondary provide a slow response, a more stable solution may be provided.

In FIG. 2, the front end of system 200, which is the secondary side, may be monitored. The secondary side AC signal may include a complex load which may include inductors, capacitors and resistors. These monitoring and switching devices may be in parallel or series, or embodiments may include a combination of such monitoring and switching devices. In FIG. 2, evaluation points B and C are two points at which the voltage and/or current may be monitored and the loads may be changed. These loads may be changed to also adjust the resonance on the secondary side and may de-tune and control the energy that may be sent to the receiver side of the system.

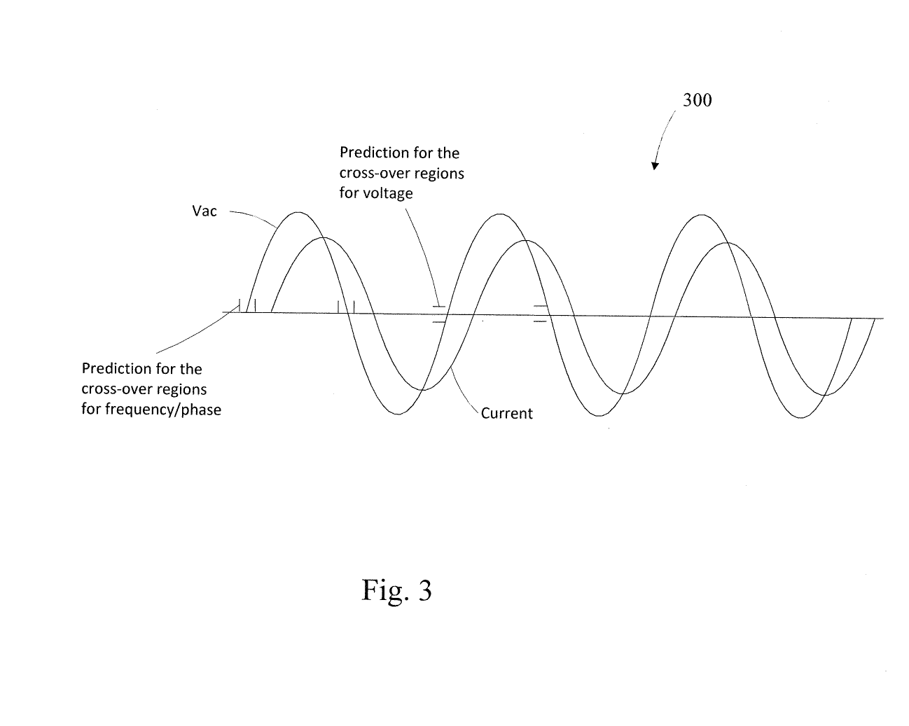

In additional embodiments of the present invention, an active system may be used to maximize the efficiency and control. FIG. 2 shows an implementation of exemplary control schemes that may be used. Initially, voltage detection may be observed and cross-over break switches X1, X2, X3, and X4 may be used to shunt diodes 202 of an asymmetric conductance device in the form of bridge 204 in higher current operation. Alternatively, current detection may also be used in a similar manner. In some embodiments of the present invention, the bridge 204 can be placed in a diode configuration for higher frequencies of energy. A PLL Control 206, controls switches X1, X2, X3, and X4 of the bridge 204. In addition, frequency and phase detection may be used at a point where the AC signal comes into the receiver, such that the frequency and phase may be predicted and/or the AC voltage waveform or current waveform may be predicted and switched by using a frequency or phase locking system. FIG. 3 illustrates an example 300 in which voltage or current levels or frequency or phase may be evaluated.

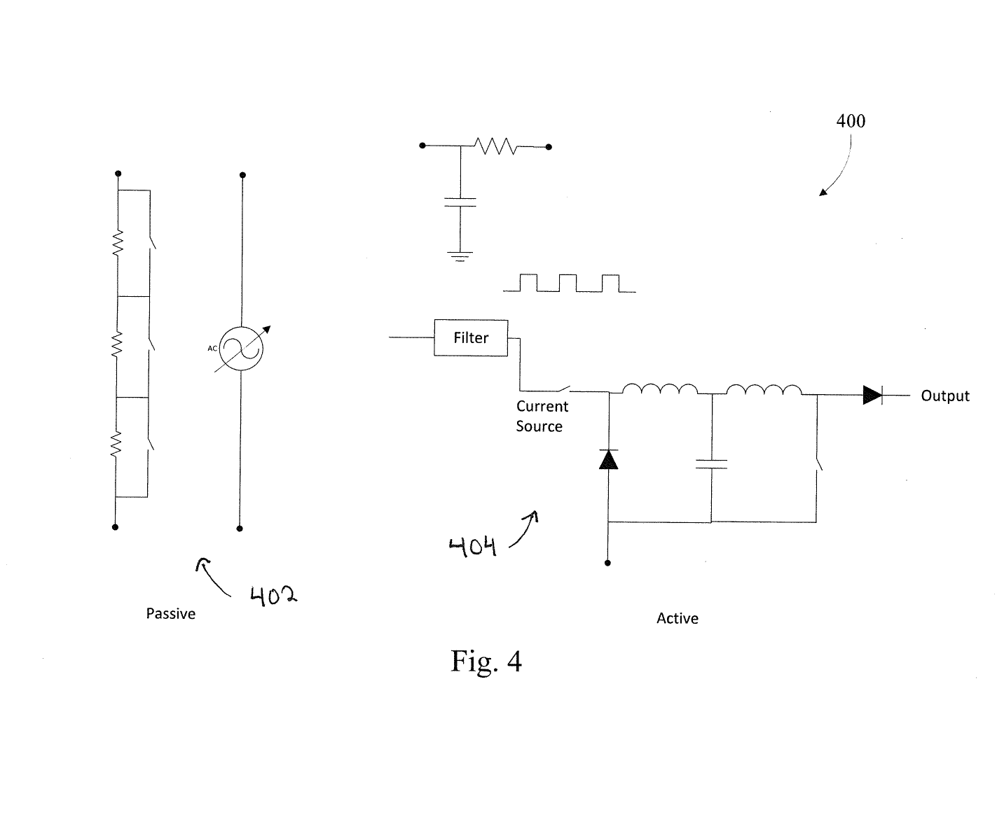

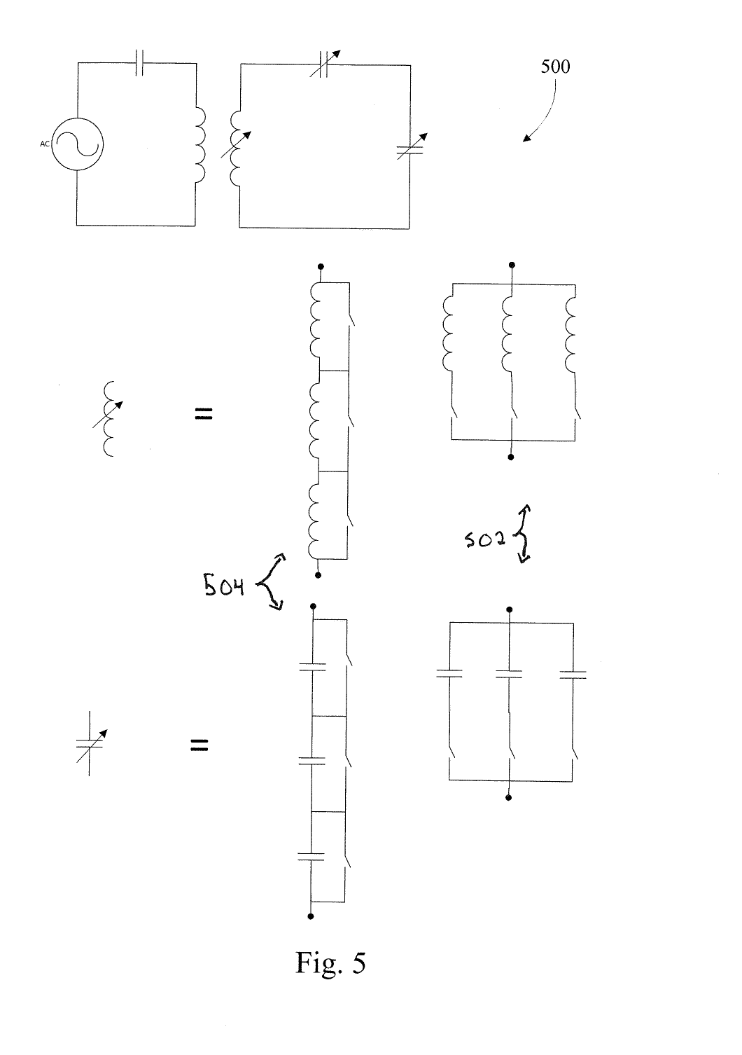

FIG. 4 illustrates embodiments of passive and active systems 400 that may be used to control the load on the secondary side, with such loads illustratively included, for instance, as part of evaluation points A and/or D of FIG. 2. A passive system 402 is shown on the left side of FIG. 4, where the passive load dissipates power. An active load system 404 is shown on the right side of FIG. 4, where the inductor/capacitor combination may be utilized to store load energy for later use. Loads may be used to dynamically and statically switch to optimize the system. Alternatively, a switch may be used to shunt passive components that may change the system load or change the complex load of the system, such as in the front end where the resonance may be changed either in series, parallel, or in combination. FIG. 5 shows some implementations of embodiments of such a system 500. These switches may be in parallel 502, series 504, or a combination. In addition, any combination of passive components could be used in series and parallel.

Loads may also be changed to adjust the resonance on the secondary side and may de-tune and control the energy that may be sent to the receiver side of the system. FIG. 5 shows some implementations of embodiments of such system 500. These switches may be in parallel 502, series 504, or a combination. In addition, any combination of passive components could be used in series and parallel.

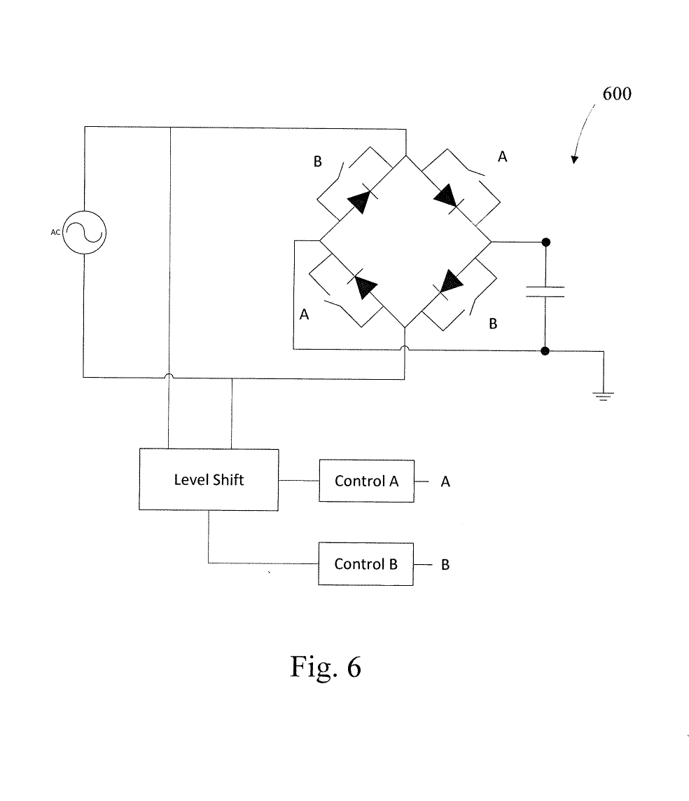

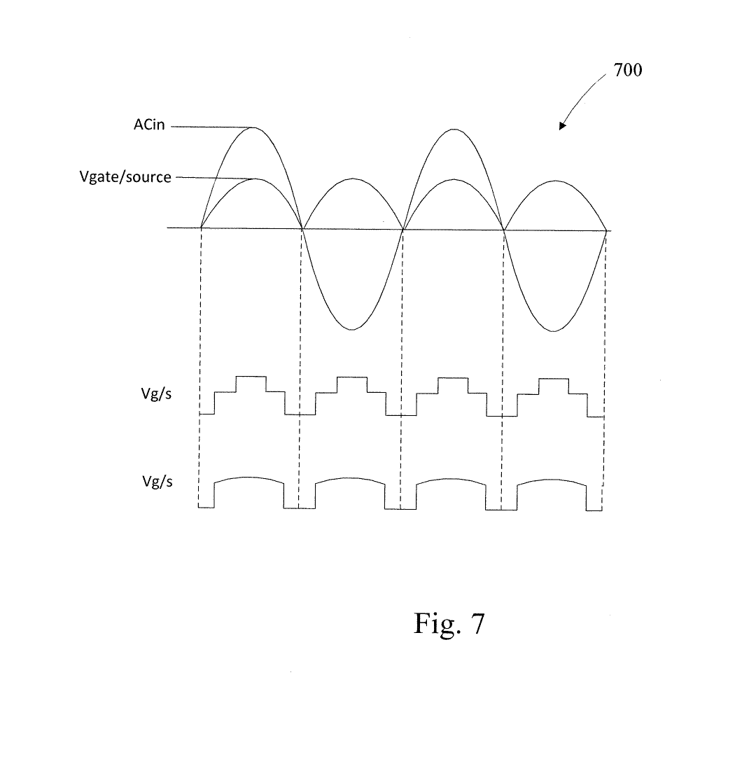

For high frequency and high voltage systems, it is challenging to efficiently switch the active devices. High frequency process components, such as SiGe or high frequency MOS or GaN or combinations may be used to minimize switching losses while maintaining a low Rds(on) for the switches. Alternatively, high voltage processes can be used to increase the voltage at the secondary side and reduce the current for the same power load. As such, the Rds(on) of the devices does not have to be as low. The gate drives of the switches of the bridge may be dynamically changed, where at larger current and/or voltage they have a higher gate drive and at lesser current and/or voltage they have the lower gate drives which would place the device in an OFF position. The control of the gate drives may be synchronized to the PLL control (e.g., 206 of FIG. 2) or to any of the signals and monitoring that is coming from the control block. These gate control signals may be level shifted either through a DC or AC interface. Such embodiments are illustrated in system 600 of FIG. 6. Alternatively, non-linear control on the gate drives may also be used such as logarithmic, or AC combined with DC switching. In other embodiments, the gate drive may be stepped so that changes result in increasing or decreasing voltage and/or current. Some examples 700 of these embodiments are illustrated in FIG. 7.

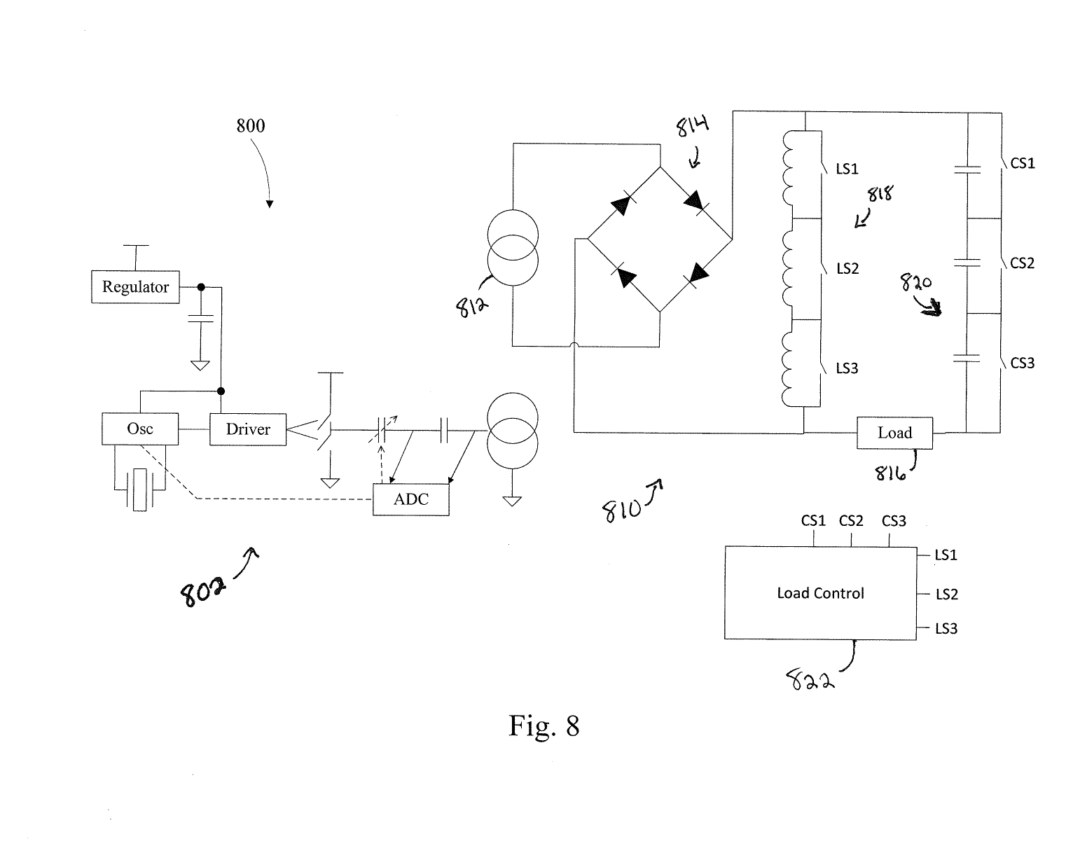

In FIG. 8, on the left, a transmitter circuit 802 may comprise a regulator tied to the bridge circuit through an input capacitor. The regulator may be linear, switching and the like. An oscillator having a crystal is electrically connected to a synchronous MOSFET driver. A feedback is electrically connected from an analog to digital converter to the oscillator. Another feedback may be connected from the analog to digital converter to an adjustable capacitor. No feedback, one feedback, or a plurality of feedbacks may be utilized in this circuit. A pair of switches connects the synchronous MOSFET driver to the adjustable capacitor.

In FIG. 8, on the right, a receiver circuit 810 comprises an antenna 812 connected to a rectification circuit 814. The load 816 is connected to an adjustable inductor bank 818 and an adjustable capacitor bank 820 to modify the load. The load control 822, controls switches LS1, LS2 and LS3 connected to the inductor bank and switches CS1, CS2 and CS3 control the capacitor bank.

Switching of the bridge and any combination may be fully diode configured, full synchronous, ½ synchronous, or asynchronous or any combination during the transfer of energy from the primary to the secondary.

Embodiments of the present invention include a high-frequency wireless power system, comprising at least one antenna port, at least one asymmetric conductance device operatively coupled to the at least one antenna port, the at least one asymmetric conductance device having a first terminal and a second terminal, at least one cross-over break switch operatively coupled across the first terminal and the second terminal and at least one control circuit operatively coupled to the at least one cross-over break switch to control the at least one cross-over break switch.

In such embodiments, the at least one asymmetric conductance device may comprise at least one of a diode and a schottky diode and may be configured as a bridge. The at least one control circuit may issue a trigger signal based on at least one of a detected frequency, a detected phase, a detected voltage and a detected current, may predict an incoming waveform and issue a trigger signal based on at least one of a frequency lock and a phase lock and may issue a trigger signal based on at least one of a phase locked loop and a frequency locked loop. The at least one cross-over break switch may be configured in at least one of a parallel configuration, a series configuration and a combination of series configuration and parallel configuration. At least one output of the at least one control circuit may output a level shifted signal or a stepped signal.

Embodiments of the present invention additionally include a high-frequency wireless power system, comprising at least one antenna port to receive at least one electromagnetic signal, at least one rectifier operatively coupled to the at least one antenna port, the at least one rectifier having a bridge configuration having at least one bridge leg, at least one cross-over break switch operatively coupled across the at least one bridge leg and at least one control circuit operatively coupled to the at least one cross-over break switch to control the at least one cross-over break switch.

In such embodiments, the at least one rectifier may comprise at least one of an active bridge and a passive bridge, may be at least one of a full bridge and a half bridge, may comprise an active bridge and wherein the active bridge comprises at least one of a fully synchronous bridge and half synchronous bridge and may comprise a dynamic bridge and wherein the dynamic bridge comprises at least one of a fully synchronous bridge, half synchronous bridge and asynchronous bridge. The at least one cross-over break switch may be configured in at least one of a parallel configuration, a series configuration and a combination of series configuration and parallel configuration.

Embodiments of the present invention further include a high-frequency wireless power system, comprising at least one antenna port to receive at least one electromagnetic signal, at least one rectifier operatively coupled to the at least one antenna port, at least one load connected to an output of the at least one rectifier bridge, at least one cross-over break switch operatively coupled across the at least one load and at least one control circuit operatively coupled to the at least one cross-over break switch to control the at least one cross-over break switch.

In such embodiments, the at least one rectifier may comprise at least one of an active bridge and a passive bridge, at least one of a full bridge and a half bridge, an active bridge and wherein the active bridge comprises at least one of a fully synchronous bridge and half synchronous bridge and a dynamic bridge and wherein the dynamic bridge comprises at least one of a fully synchronous bridge, half synchronous bridge and asynchronous bridge. The at least one cross-over break switch may be configured in at least one of a parallel configuration, a series configuration and a combination of series configuration and parallel configuration. The at least one load may be an active load such as a combination of at least one inductor and at least one capacitor. The active load may be adjusted based on the active load state. At least one output of the at least one control circuit may output a level shifted or stepped signal.

Furthermore still, embodiments of the present invention include a high-frequency wireless power system, comprising at least one antenna port to receive at least one electromagnetic signal, at least one bridge rectifier operatively coupled to the at least one antenna port, at least one load connected to an output of the at least one rectifier configured as a diode bridge, at least one load switch operatively coupled to the at least one load and at least one control circuit operatively coupled to the at least one load switch to control the at least one load switch. In this example, the at least one bridge rectifier may comprise at least one of an active bridge, a passive bridge, a full bridge and a half bridge. The at least one load switch may be configured in at least one of a parallel configuration, a series configuration and a combination of series configuration and parallel configuration.

While the making and using of various exemplary examples of the disclosure are discussed herein, it is to be appreciated that the present disclosure provides concepts which can be described in a wide variety of specific contexts. It is to be understood that the device and method may be practiced with cell phones, personal digital assistants, laptop computers, tablet computers, portable batteries and associated apparatus. For purposes of clarity, detailed descriptions of functions, components, and systems familiar to those skilled in the applicable arts are not included. The methods and apparatus of the disclosure provide one or more advantages including which are not limited to, portable energy and high efficiency passive charging of devices. While the disclosure has been described with reference to certain illustrative examples, those described herein are not intended to be construed in a limiting sense. For example, variations or combinations of steps or materials in the examples shown and described may be used in particular cases while not departing from the disclosure. Various modifications and combinations of the illustrative examples as well as other advantages and examples will be apparent to persons skilled in the arts upon reference to the drawings, description, and claims.

What is claimed is:

1. A high-frequency wireless power system, comprising:
at least one antenna port;
at least one asymmetric conductance device operatively coupled to said at least one antenna port, said at least one asymmetric conductance device having a first terminal and a second terminal;
at least one cross-over break switch operatively coupled across said first terminal and said second terminal; and
at least one control circuit operatively coupled to said at least one cross-over break switch to control said at least one cross-over break switch.

2. The high-frequency wireless power system of claim 1 wherein said at least one asymmetric conductance device comprises at least one of a diode and a schottky diode.

3. The high-frequency wireless power system of claim 1 wherein said at least one asymmetric conductance device is configured as a bridge.

4. The high-frequency wireless power system of claim 1 wherein said at least one control circuit issues a trigger signal based on at least one of frequency, phase, voltage and current.

5. The high-frequency wireless power system of claim 1 wherein said at least one control circuit predicts a waveform and issues a trigger signal based on at least one of frequency lock and phase lock.

6. The high-frequency wireless power system of claim 1 wherein said at least one cross-over break switch is configured in at least one of a parallel configuration, a series configuration and a combination of series configuration and parallel configuration.

7. The high-frequency wireless power system of claim 1 wherein said at least one cross-over break switch is synchronous.

8. The high-frequency wireless power system of claim 1 wherein at least one output of said at least one control circuit outputs a level shifted signal.

9. The high-frequency wireless power system of claim 1 wherein at least one output of said at least one control circuit outputs a stepped signal.

10. The high-frequency wireless power system of claim 1 wherein said at least one control circuit comprises at least one of a frequency lock loop and a phase lock loop.

11. A high-frequency wireless power system, comprising:
at least one antenna port to receive at least one electromagnetic signal;
at least one rectifier operatively coupled to said at least one antenna port, said at least one rectifier having a bridge configuration having at least one bridge leg;
at least one cross-over break switch operatively coupled across said at least one bridge leg; and
at least one control circuit operatively coupled to said at least one cross-over break switch to control said at least one cross-over break switch.

12. The high-frequency wireless power system of claim 11 wherein said at least one rectifier comprises at least one of an active bridge and a passive bridge.

13. The high-frequency wireless power system of claim 11 wherein said at least one rectifier comprises at least one of a full bridge and a half bridge.

14. The high-frequency wireless power system of claim 11 wherein said at least one rectifier comprises an active bridge and wherein said active bridge comprises at least one of a fully synchronous bridge and half synchronous bridge.

15. The high-frequency wireless power system of claim 11 wherein said at least one rectifier comprises a dynamic bridge and wherein said dynamic bridge comprises at least one of a fully synchronous bridge, half synchronous bridge and asynchronous bridge.

16. The high-frequency wireless power system of claim 11 wherein said at least one cross-over break switch is configured in at least one of a parallel configuration, a series configuration and a combination of series configuration and parallel configuration.

17. A high-frequency wireless power system, comprising:
at least one antenna port to receive at least one electromagnetic signal;
at least one bridge rectifier operatively coupled to said at least one antenna port;
at least one load connected to an output of said at least one rectifier configured as a diode bridge;
at least one load switch operatively coupled to said at least one load; and
at least one control circuit operatively coupled to said at least one load switch to control said at least one load switch.

18. The high-frequency wireless power system of claim 17 wherein said at least one bridge rectifier comprises at least one of an active bridge and a passive bridge.

19. The high-frequency wireless power system of claim 17 wherein said at least one bridge rectifier comprises at least one of a full bridge and a half bridge.

20. The high-frequency wireless power system of claim 17 wherein said at least one load switch is configured in at least one of a parallel configuration, a series configuration and a combination of series configuration and parallel configuration.
